(19) United States
(12) Patent Application Publication
(10) Pub. No.: US 2025/0263098 A1
(43) Pub. Date: Aug. 21, 2025

(54) MOTORIZED HUNTING CART DEVICE

(71) Applicant: Jason Key, Newaygo, MI (US)

(72) Inventor: Jason Key, Newaygo, MI (US)

(21) Appl. No.: 18/443,510

(22) Filed: Feb. 16, 2024

(51) Int. Cl. B62B 1/02; B62B 5/00; B62B 5/04

(52) U.S. Cl. CPC B62B 1/02; B62B 5/0033; B62B 5/0079; B62B 5/0447

(57) ABSTRACT

A motorized hunting cart device is provided. The device is comprised of a motorizing hunting cart device that can be used to allow a hunter to transport a dead game animal with minimal physical effort. To do so, the device preferably has two wheels and an electric motor that can quietly transport a dead game animal in the body of the device. The device can be steered via a handle, wherein the handle is comprised of at least one trigger that activates the motor.

### FIELD OF THE INVENTION

The present invention relates generally to the field of hunting. More specifically, the present invention relates to a motorized hunting cart device that provides a hunter with a small, motorized cart that can be used to transport a dead game animal. Accordingly, the present disclosure makes specific reference thereto. Nonetheless, it is to be appreciated that aspects of the present invention are also equally applicable to other like applications, devices, and methods of manufacture.

### BACKGROUND

After killing an animal, a hunter must transport the animal to a secondary location such as a camp, a vehicle, etc. This is typically done by carrying or dragging the dead animal. However, depending on the size of the animal and the physical strength/ability of the hunter, this process can be exceptionally physically taxing. As a result, some individuals may use small UTVs, ATVs, or other motorized vehicles to transport a dead animal. However, said vehicles produce noise that can scare away other nearby animals which may be undesirable for the hunter and/or other hunters.

Therefore, there exists a long-felt need in the art for a device for transporting a dead game animal. There also exists a long-felt need in the art for a motorized hunting cart device that can be used to transport a dead game animal in a manner that requires little physical effort on the part of the user. In addition, there exists a long-felt need in the art for a motorized hunting cart device that can be used to transport a dead game animal in a manner that requires little physical effort on the part of the user and wherein the device is quiet when in use.

The subject matter disclosed and claimed herein, in one embodiment thereof, comprises a motorized hunting cart device. The device is comprised of a motorizing hunting cart device that can be used to allow a hunter to transport a dead game animal with minimal physical effort. The device is preferably comprised of two wheels and an electric motor that can quietly transport a dead game animal in the body of the device. The device can be steered via a handle, wherein the handle is comprised of at least one trigger that activates the motor.

In this manner, the motorized hunting cart device of the present invention accomplishes all the foregoing objectives and provides a device for transporting a dead game animal. While doing so, the device requires little physical effort on the part of the user. In addition, the device is quiet when in use due to the electric motor.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a motorized hunting cart device. The device is comprised of a body with an interior space, at least one handle with at least one trigger, and at least one wheel. The device is designed to allow a hunter to easily transport a game animal that has been killed to eliminate the need for a hunter to manually drag the game animal, use an unpowered wheelbarrow or other device, or use a larger vehicle to do so.

The body may be any shape and size to accommodate any game animal known in the art such as, but not limited to, deer, elk, moose, etc. The game animal can be stored in the interior space during use. To allow the interior space to be easily cleaned after being used to transport a dead game animal, the interior space may be comprised of at least one drainage opening that allows blood, debris, etc., to drain from the interior space while the interior space is washed after a hunt. The drain opening can be plugged with at least one removable drain plug when not in use.

The device is comprised of at least one, but preferably two wheels attached to at least one axle. The wheels can be propelled forward and backward via at least one motor which spins the axle. The motor is preferably an electric motor powered by at least one battery. The electric motor allows the device to remain quiet such as to not scare away any game animals during use.

The body is comprised of at least one handle to allow a user to push/pull and otherwise maneuver the body during use. The handle is also comprised of a first trigger that allows a user to activate the motor to rotate the axle and propel the wheels forward. In another embodiment, a second trigger on the handle allows a user to activate the motor to rotate the axle and propel the wheels backward. In addition, each wheel may be comprised of at least one brake that allows a user to stop the rotation of the wheels via pressing at least one brake lever on the handle.

The device may also be comprised of a tow hitch. The hitch allows the device to be towed behind a vehicle when not in use. In addition, the device may be comprised of at least one support leg that allows the device to stand when not in use. The leg may be any shape and size known in the art.

The present invention is also comprised of a method of using the device. First, a device is provided comprised of a body comprised of at least one wheel, at least one motor, and at least one trigger on at least one handle. Then, a user can load a dead game animal into an interior space of the body. Next, a user can pull the trigger to cause the motor to turn the wheel forward to propel the device forward to transport the dead game animal.

A similar method of using the device involves providing a device comprised of a body comprised of at least one wheel, at least one motor, and at least one trigger on at least one handle. Then, a user can load a dead game animal into an interior space of the body. Next, a user can pull the trigger to cause the motor to turn the wheel backward to propel the device forward to transport the dead game animal.

Another method of using the device is comprised of providing a device comprised of a body comprised of at least one wheel, at least one motor, and a first trigger and a second trigger positioned on at least one handle. Then, a user can load a dead game animal into an interior space of the body. Next, a user can pull a trigger to cause the motor to turn the wheel forward or backward to propel the device forward to transport the dead game animal. Then, a user can pull a brake lever to brake the device while moving forward or backward.

Accordingly, the motorized hunting cart device of the present invention is particularly advantageous as it provides a device for transporting a dead game animal. During use, the device can be used to transport a dead game animal in a manner that requires little physical effort on the part of the user. In addition, the electric motor ensures the device is quiet when in use. In this manner, the motorized hunting cart device provides a novel solution for hunters looking to transport a dead game animal while hunting.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a motorized hunting cart device of the present invention in accordance with the disclosed architecture;

FIG. 2 illustrates a flowchart of a method of using one potential embodiment of a motorized hunting cart device of the present invention in accordance with the disclosed architecture;

FIG. 3 illustrates a flowchart of a method of using one potential embodiment of a motorized hunting cart device of the present invention in accordance with the disclosed architecture;

FIG. 4 illustrates a flowchart of a method of using one potential embodiment of a motorized hunting cart device of the present invention in accordance with the disclosed architecture; and

FIG. 5 illustrates a perspective view of a base of one potential embodiment of a motorized hunting cart device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a device for transporting a dead game animal. There also exists a long-felt need in the art for a motorized hunting cart device that can be used to transport a dead game animal in a manner that requires little physical effort on the part of the user. In addition, there exists a long-felt need in the art for a motorized hunting cart device that can be used to transport a dead game animal in a manner that requires little physical effort on the part of the user and wherein the device is quiet when in use.

The present invention, in one exemplary embodiment, is comprised of a motorized hunting cart device. The device is comprised of a body with an interior space, at least one handle with at least one trigger, and at least one wheel. The device is designed to allow a hunter to easily transport a game animal that has been killed to eliminate the need for a hunter to manually drag the game animal, use an unpowered wheelbarrow or other device, or use a larger vehicle to do so.

The body may be any shape and size to accommodate any game animal known in the art such as, but not limited to, deer, elk, moose, etc., wherein the game animal can be stored in the interior space during use. To allow the interior space to be easily cleaned after being used to transport a dead game animal, the interior space may be comprised of at least one drainage opening that allows blood, debris, etc., to drain from the interior space while the interior space is washed after a hunt. The drain opening can be plugged with at least one removable drain plug when not in use.

The device is comprised of at least one, but preferably two wheels. The wheels are attached to at least one axle. The wheels can be propelled forward and backward via at least one motor which spins the axle. The motor is preferably an electric motor powered by at least one battery. The electric motor allows the device to remain quiet such as to not scare away any game animals during use.

The body is comprised of at least one handle to allow a user to push/pull and otherwise maneuver the body during use. The handle is also comprised of a first trigger that allows a user to activate the motor to rotate the axle and propel the wheels forward. In another embodiment, a second trigger on the handle allows a user to activate the motor to rotate the axle and propel the wheels backward. In addition, each wheel may be comprised of at least one brake that allows a user to stop the rotation of the wheels via pressing at least one brake lever on the handle.

The device may also be comprised of a tow hitch. The hitch allows the device to be towed behind a vehicle when not in use. In addition, the device may be comprised of at least one support leg that allows the device to stand when not in use. The leg may be any shape and size known in the art.

The present invention is also comprised of a method of using the device. First, a device is provided comprised of a body comprised of at least one wheel, at least one motor, and at least one trigger on at least one handle. Then, a user can load a dead game animal into an interior space of the body. Next, a user can pull the trigger to cause the motor to turn the wheel forward to propel the device forward to transport the dead game animal.

A similar method of using the device involves providing a device comprised of a body comprised of at least one wheel, at least one motor, and at least one trigger on at least one handle. Then, a user can load a dead game animal into an interior space of the body. Next, a user can pull the trigger to cause the motor to turn the wheel backward to propel the device forward to transport the dead game animal.

An additional method of using the device is comprised of providing a device comprised of a body comprised of at least one wheel, at least one motor, and a first trigger and a second trigger positioned on at least one handle. Then, a user can load a dead game animal into an interior space of the body. Next, a user can pull a trigger to cause the motor to turn the wheel forward or backward to propel the device forward to transport the dead game animal. Then, a user can pull a brake lever to brake the device while moving forward or backward.

Accordingly, the motorized hunting cart device of the present invention is particularly advantageous as it provides a device for transporting a dead game animal. During use, the device can be used to transport a dead game animal in a manner that requires little physical effort on the part of the user. In addition, the electric motor ensures the device is quiet when in use. In this manner, the motorized hunting cart device provides a novel solution for hunters looking to transport a dead game animal while hunting.

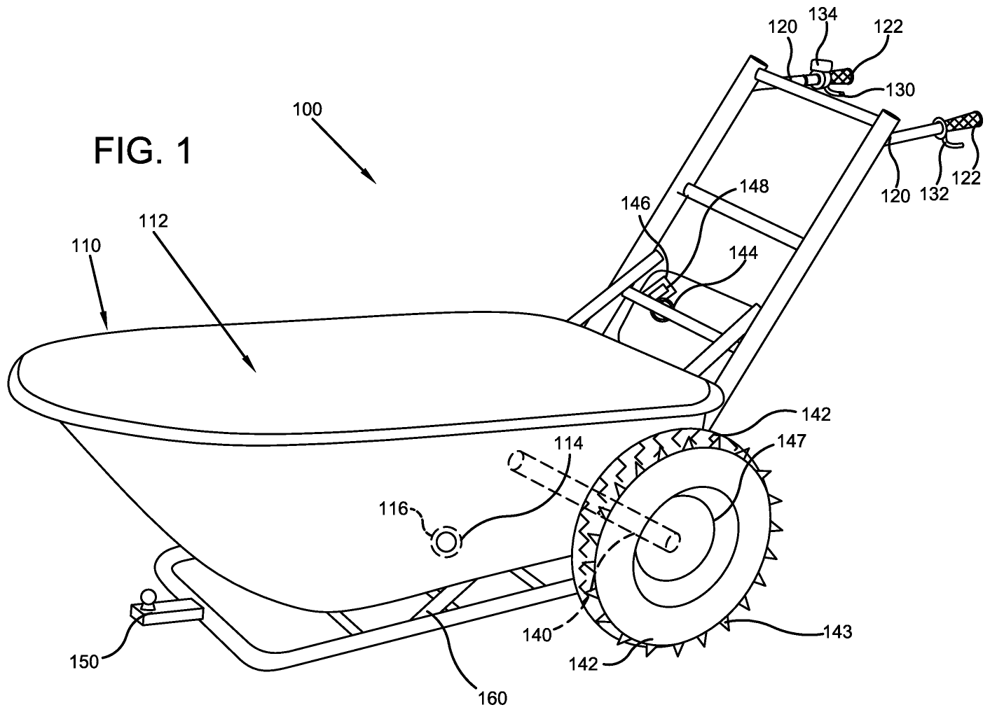

Referring initially to the drawings, FIG. 1 illustrates a perspective view of one potential embodiment of a motorized hunting cart device 100 of the present invention in accordance with the disclosed architecture. The device 100 is comprised of a body 110 with an interior space 112, at least one handle 120 with at least one trigger 130,132, and at least one wheel 142. The device 100 is designed to allow a hunter to easily transport a game animal that has been killed. This eliminates the need for a hunter to manually drag the game animal, use an unpowered wheelbarrow or other device, or use a larger vehicle to do so.

The body 110 is preferably comprised of a rigid plastic or a lightweight metal material. The body 110 may be any shape and size to accommodate any game animal known in the art such as, but not limited to, deer, elk, moose, etc. The game animal can be stored in the interior space 112 during use. The body 110 may resemble a deer cart, a wheelbarrow, a dolly, etc. or any other material or animal transporting structure.

To allow the interior space 112 to be easily cleaned after being used to transport a dead game animal, the interior space 112 may be comprised of at least one drainage opening 116. The opening 116 allows blood, debris, etc., to drain from the interior space 112 while the interior space 112 is washed after a hunt. The drain opening 116 can be plugged with at least one removable drain plug 114 when not in use.

The body 110 is comprised of at least one handle 120 to allow a user to push/pull and otherwise maneuver the body 110 during use. In one embodiment, the handle is comprised of at least one grip area 122. The grip area 122 is preferably made from a non-slip material such as, but not limited to, rubber to improve grip on the handle 120. The grip area 122 may also be textured with a raised or recessed texture to improve grip.

The device 100 is comprised of at least one, but preferably two wheels 142 attached to at least one axle 140. The wheels 142 can be propelled forward and backward via at least one motor 144 which spins the axle 140. The motor 144 is preferably an electric motor powered by at least one battery 146. The battery 146 is preferably a removable, rechargeable battery. In one embodiment, the battery 146 can be recharged via at least one charging port 148 of any type known in the art. The electric motor 144 allows the device 100 to remain quiet such as to not scare away any game animals during use. However, the motor 144 may be a gasoline motor in another embodiment.

The wheels 142 may be any type and style of wheels such as, but not limited to, inflatable wheels, run-flat wheels, etc. In one embodiment, the wheels 142 are textured with at least one raised stud 143 to help the wheels 142 traverse obstacles in the path of the device 100 such as, but not limited to, fallen trees and logs.

The handle 120 is also comprised of a first trigger 130. The trigger 130 allows a user to activate the motor 144 to rotate the axle 140 and propel the wheels 142 forward. In another embodiment, a second trigger 132 on the handle 120 allows a user to activate the motor 144 to rotate the axle 140 and propel the wheels 142 backward. In addition, each wheel 142 may be comprised of at least one brake 147. The brake 147 may be any style of brake known in the art. The brake 147 allows a user to stop the rotation of the wheels 142 via pressing at least one brake lever 134 on the handle 120. In one embodiment, the device 100 has two parallel handles 120 that protrude from the body 110 similar to wheelbarrow handles.

The device 100 may also be comprised of a tow hitch 150. The hitch 150 allows the device 100 to be towed behind a vehicle when not in use. The hitch 150 is preferably a ball hitch, but may be any hitch type known in the art.

In addition, the device 100 may be comprised of at least one support leg 160. The leg 160 allows the device 100 to stand when not in use. The leg 160 may be any shape and size known in the art.

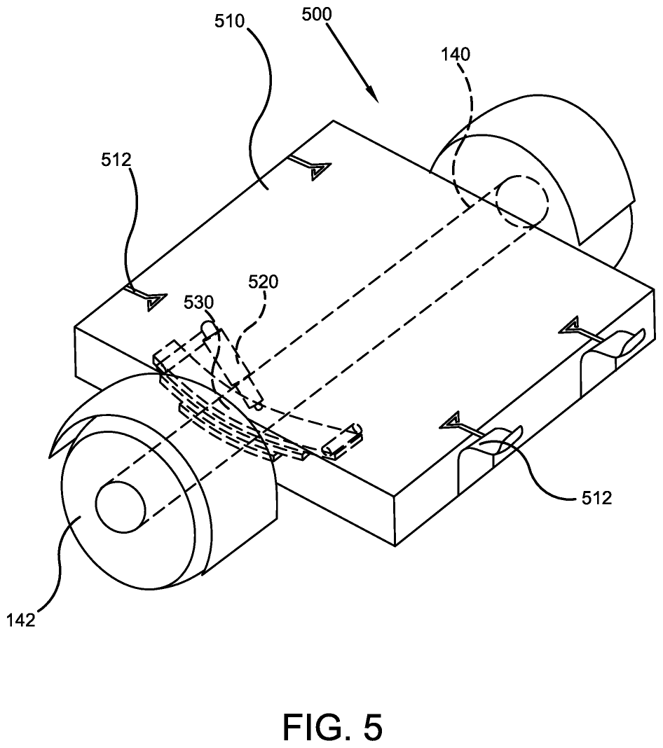

In one embodiment, the device 100 is comprised of a base 500, wherein the base 500 is comprised of at least one at least one, but preferably two wheels 142 attached to at least one axle 140, as seen in FIG. 5. The wheels 142 can be propelled forward and backward via at least one motor 144 which spins the axle 140. The wheels 142 preferably have an independent suspension 520 with at least one shock absorber 530. The motor 144 is preferably an electric motor powered by at least one battery 146. The battery 146 is preferably a removable, rechargeable battery. In one embodiment, the battery 146 can be recharged via at least one charging port 148 of any type known in the art. The electric motor 144 allows the device 100 to remain quiet such as to not scare away any game animals during use. However, the motor 144 may be a gasoline motor in another embodiment.

The wheels 142 may be any type and style of wheels such as, but not limited to, inflatable wheels, run-flat wheels, etc. In one embodiment, the wheels 142 are textured with at least one raised stud 143 to help the wheels 142 traverse obstacles in the path of the device 100 such as, but not limited to, fallen trees and logs.

In this embodiment, the base 500 is comprised of at least one mounting surface 510 that receives the body 110. More specifically, the body 110 attaches to the surface 510 via at least one fastener 512 such as but not limited to a clip, a clamp, a snap fastener, a bolt, a locking member, etc. In this manner, a user can interchange the body 110 style with the base 500 for the desired application.

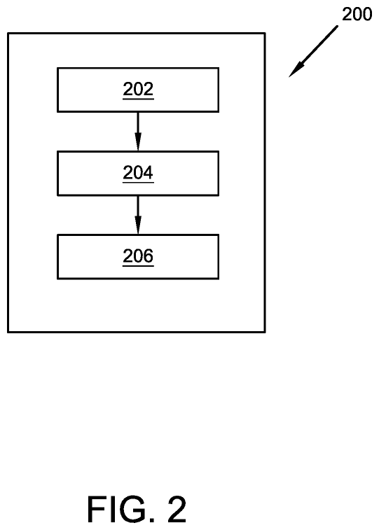

The present invention is also comprised of a method of using 200 the device 100, as seen in FIG. 2. First, a device 100 is provided comprised of a body 110 comprised of at least one wheel 142, at least one motor 144, and at least one trigger 130 on at least one handle 120 [Step 202]. Then, a user can load a dead game animal into an interior space 112 of the body 110 [Step 204]. Next, a user can pull the trigger 130 to cause the motor 144 to turn the wheel 142 forward to propel the device 100 forward to transport the dead game animal [Step 206].

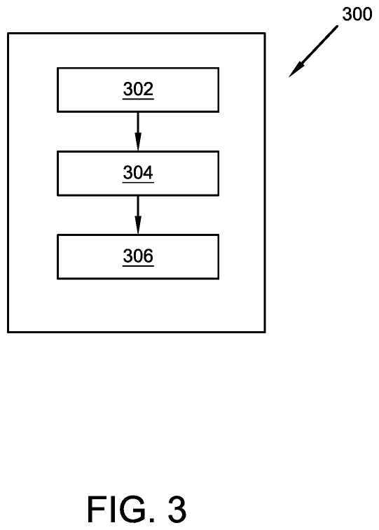

The present invention is also comprised of a method of using 300 the device 100, as seen in FIG. 3. First, a device 100 is provided comprised of a body 110 comprised of at least one wheel 142, at least one motor 144, and at least one trigger 130 on at least one handle 120 [Step 302]. Then, a user can load a dead game animal into an interior space 112 of the body 110 [Step 304]. Next, a user can pull the trigger 130 to cause the motor 144 to turn the wheel 142 backward to propel the device 100 forward to transport the dead game animal [Step 306].

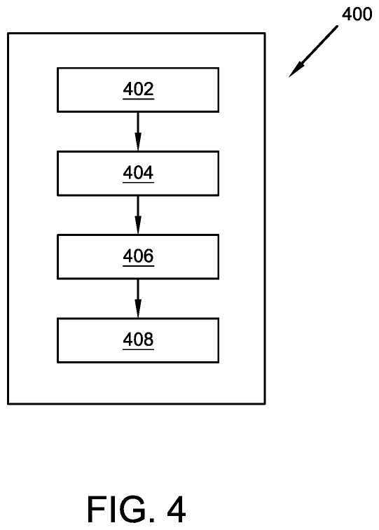

The present invention is also comprised of a method of using 400 the device 100, as seen in FIG. 4. First, a device 100 is provided comprised of a body 110 comprised of at least one wheel 142, at least one motor 144, and a first trigger 130 and a second trigger 132 positioned on at least one handle 120 [Step 402]. Then, a user can attached the body 110 to a base 500 of the device 100 via at least one fastener 152 and then load a dead game animal into an interior space 112 of the body 110 [Step 404]. Next, a user can pull a trigger 130 and a second trigger 132 to cause the motor 144 to turn the wheel 142 forward or backward to propel the device 100 forward to transport the dead game animal [Step 406]. Then, a user can pull a brake lever 134 to brake the device 100 while moving forward or backward [Step 408].

Certain terms are used throughout the following description and claims to refer to particular features or components. As one skilled in the art will appreciate, different persons, may refer to the same feature or component by different names. This document does not intend to distinguish between components or features that differ in name but not structure or function. As used herein “motorized hunting cart device” and “device” are interchangeable and refer to the motorized hunting cart device 100 of the present invention.

Notwithstanding the foregoing, the motorized hunting cart device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the motorized hunting cart device 100 as shown in the FIGS. are for illustrative purposes only, and that many other sizes and shapes of the motorized hunting cart device 100 are well within the scope of the present disclosure. Although the dimensions of the motorized hunting cart device 100 are important design parameters for user convenience, the motorized hunting cart device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A motorized hunting cart device comprising:
a body comprised of an interior space;
a handle
a trigger positioned on the handle;
an axle having a wheel; and
a motor.

2. The motorized hunting cart device of claim 1, wherein the wheel is comprised of a stud.

3. The motorized hunting cart device of claim 1, wherein the trigger activates the motor to rotate the axle.

4. The motorized hunting cart device of claim 3, wherein the motor rotates the axle forward.

5. The motorized hunting cart device of claim 3, wherein the motor rotates the axle backward.

6. The motorized hunting cart device of claim 1, wherein the handle is comprised of a grip area.

7. The motorized hunting cart device of claim 6, wherein the grip area is comprised of a non-slip rubber material.

8. The motorized hunting cart device of claim 6, wherein the grip area is comprised of a raised or a recessed texture.

9. A motorized hunting cart device comprising:
a body comprised of an interior space, an opening, and a drain plug;
a first handle comprised of a first trigger and a brake lever;
an axle comprised of a wheel, wherein the wheel is comprised of a brake;
a motor; and
a battery.

10. The motorized hunting cart device of claim 9, wherein the motor is comprised of an electric motor.

11. The motorized hunting cart device of claim 9, wherein the battery is comprised of a removable battery.

12. The motorized hunting cart device of claim 11, wherein the battery is comprised of a charging port.

13. The motorized hunting cart device of claim 9, wherein the first trigger activates the motor.

14. The motorized hunting cart device of claim 9, wherein the motor rotates the axle.

15. The motorized hunting cart device of claim 9 further comprised of a second handle.

16. The motorized hunting cart device of claim 15, wherein the first handle is parallel to the second handle.

17. The motorized hunting cart device of claim 15, wherein the second handle is comprised of a second trigger.

18. A method of using a motorized hunting cart device, the method comprising the following steps:
providing a motorized hunting cart device comprised of a body comprised of a wheel, a motor, and a trigger positioned on a handle;
loading a dead game animal into an interior space of the body; and
pulling the trigger to propel the motorized hunting cart device.

19. The method of claim 18, wherein pulling the trigger propels the motorized hunting cart device forward.

20. The method of claim 18, wherein pulling the trigger propels the motorized hunting cart device backward.
